(19) United States
(12) Patent Application Publication
(10) Pub. No.: US 2016/0325417 A1
(43) Pub. Date: Nov. 10, 2016

(54) OIL FILTER REMOVAL TOOL

(71) Applicant: THOMAS L. KLAMM, RACINE, WI (US)

(72) Inventor: THOMAS L. KLAMM, RACINE, WI (US)

(21) Appl. No.: 15/217,346

(22) Filed: Jul. 22, 2016

Related U.S. Application Data
(63) Continuation-in-part of application No. 14/688,612, filed on Apr. 16, 2015.

(51) Int. Cl. B25B 27/00; B25B 13/50; B25B 13/28

(52) U.S. Cl. CPC B25B 27/0042; B25B 13/28; B25B 13/5008

(57) ABSTRACT

A tool for removing an oil filter from an engine includes a wrench with a body from which a plurality of fingers pivotally project. Each finger has a remote end section from which a projection extends to compressively engage the oil filter. A drive mechanism causes the fingers to pivot with respect to the body. A flexible boot has a cylindrical shape with an open end and a smaller closed end and an exterior surface that is contacted by a rod of the wrench prior to engaging the oil filter. The boot catches and retains oil leakage during removal of an oil filter. The drive mechanism is adapted to have a handle removably attached thereto.

### CROSS-REFERENCE TO RELATED APPLICATIONS

This application is a continuation-in-part of U.S. patent application Ser. No. 14/688,612 filed on Apr. 16, 2015. This application claims priority based on the aforementioned application which is hereby incorporated by reference.

### STATEMENT REGARDING FEDERALLY SPONSORED RESEARCH OR DEVELOPMENT

Not Applicable.

### BACKGROUND OF THE INVENTION

1. Field of the Invention

The present invention relates to tools for removing an oil filter from attachment to an internal combustion engine.

2. Description of the Related Art

An internal combustion engine is lubricated by oil that is circulated through a filter. Periodically the oil and the filter have to be replaced. A typical automobile oil filter is threaded onto a nipple that projects from the engine. A wrench often is required to remove the existing filter and several different types of wrenches have been developed for this purpose. Most of those wrenches are designed to be turned by a standard ratchet type handle.

One common style of an oil filter wrench is a cap with a polygonal sidewall that fits onto the bottom end of the oil filter that has a matching polygonal sidewall. The drawback of this style is that the wrench fits only one size of filter body and a motor vehicle service center or garage needs to have an assortment of such wrenches in different sizes.

Another style of oil filter wrench has movable fingers that adjust to grip different sizes of oil filters. An example of this style of wrench is shown in U.S. design patent D348,814. In order to aid the fingers to grip the filter housing, the ends of the fingers have plastic covers. However, the plastic covers can wear through or fall off and get lost over time. Therefore, a better mechanism for gripping the filter body is desired for this style of oil filter wrench.

Another problem with all styles of oil filter wrenches, is that as the filter is loosened from the engine, oil that remains in the filter and in the adjacent region of the engine leaks out falling onto components of the motor vehicle and the floor there under. The leaking oil also can burn a person's hands. U.S. published patent application no. 2012/0198970 addresses this problem by attaching a cylindrical bellows to a conventional cap style oil filter wrench to catch the leaking oil during removal of an existing oil filter. Because this tool uses a cap style wrench, it only works with one size of oil filter.

Therefore, a need still exists for an oil filter wrench that can be used with oil filters of different sizes and catch oil that leaks from the filter during removal.

### SUMMARY OF THE INVENTION

A tool for removing an oil filter from an engine comprises a wrench, a boot surrounding the wrench, and a shaft attached to the wrench and extending out of the boot.

The wrench includes a body from which a plurality of fingers pivotally project. Each finger has a remote end section from which a rod projects in an orientation to engage the oil filter. The wrench further includes a drive mechanism, that when rotated, causes the fingers to pivot with respect to the body.

In one embodiment of the wrench, a circular gear with teeth is rotationally connected to the body. A drive mechanism is attached to the circular gear and is adapted to be engaged by a handle. The plurality of fingers are pivotally connected to the body and curve outward there from in a common plane. Each finger has a proximate end section with teeth that mesh with the teeth of the circular gear and its remote end section is transverse to the common plane.

The boot is fabricated of flexible material and has a curved frusto-conical shape with an open end and a smaller closed end with a first aperture there through. The wrench is located within the boot.

The shaft is attached to the drive mechanism of the wrench and extends through the first aperture of the boot. Rotating the shaft with respect to the wrench body causes the fingers to pivot with respect to the wrench body.

In use, the boot is placed over the oil filter to be removed until the oil filter is located between the fingers of the wrench. Then, the shaft is rotated causing the fingers pivot to toward the oil filter so that the rods engage and firmly grip the housing of the oil filter. Continued rotation of the shaft causes the wrench and the oil filter to rotate, thereby loosening the oil filter from the engine.

In another embodiment, a tool for removing an oil filter engine comprises a wrench, a boot, and a shaft, wherein the wrench is located outside the boot and the shaft is attached to the drive mechanism of the wrench.

The wrench includes a body from which a plurality of fingers pivotally project. Each finger has a remote end section from which a rod projects in an orientation to compressively engage the oil filter. The wrench further comprises a drive mechanism that, when rotated, causes the fingers to pivot with respect to the body.

The boot is fabricated of flexible material and has a cylindrical shape with a first end that is open and second end that is closed. The boot has an exterior surface located such that each rod of the wrench contacts the exterior surface of the boot prior to engaging the oil filter.

In another embodiment, a tool for removing an oil filter engine comprises a wrench, a boot, and a shaft, wherein the wrench is located outside the boot and the shaft is attached to the drive mechanism of the wrench.

The wrench includes a body from which a plurality of fingers pivotally project. Each finger has a remote end section from which a rod projects in an orientation to compressively engage the oil filter. The wrench further comprises a drive mechanism that, when rotated, causes the fingers to pivot with respect to the body.

The boot is fabricated of flexible material and has a cylindrical shape with a first end that is open and second end that is closed. The boot has an exterior surface located such that each rod of the wrench contacts the exterior surface of the boot prior to engaging the oil filter. The boot has an interior surface comprising a plurality of flutes.

### BRIEF DESCRIPTION OF THE DRAWINGS

FIG. 1 is a side view of an oil filter removal tool according to the present invention;

FIG. 2 is a longitudinal cross-sectional view through the tool in FIG. 1;

FIG. 3 is a top view of a wrench in the tool for gripping an oil filter;

FIG. 4 is a side view of the wrench;

FIG. 5 is a view of the wrench with a top plate removed to show the internal components;

FIG. 6 is a side view of an oil filter removal tool with its boot in a compressed state;

FIG. 7 is a front view of an alternative oil filter removal tool according to the present invention;

FIG. 8 is a longitudinal cross-sectional view through the tool in FIG. 7;

FIG. 9 is an isometric view of an alternative wrench that can be used in the tool for gripping an oil filter;

FIG. 10 is a top view of the alternative wrench with a top plate removed to show the internal components;

FIG. 11 is a front view of the alternative wrench;

FIG. 12 is a top isometric view of an alternate embodiment of a boot;

FIG. 13 is a front view of the alternate embodiment of the boot;

FIG. 14 is a longitudinal cross-sectional view of the boot in FIG. 13, where the diaphragm is in its original shape;

FIG. 15 is a longitudinal cross-sectional view of the boot in FIG. 13, where the diaphragm is in an inverted state to accommodate a larger oil filter;

FIG. 16 is a longitudinal cross-sectional view of the boot in FIG. 13, where the diaphragm is in a completely inverted state to accommodate a larger oil filter; and

FIG. 17 is a top view of the alternate embodiment of the boot.

### DETAILED DESCRIPTION OF THE INVENTION

Reference herein to directional relationships and movement, such as top and bottom or left and right, refer to the relationship and movement of the components in the orientation illustrated in the drawings, which may not be the orientation of the components when the oil filter removal tool is in use.

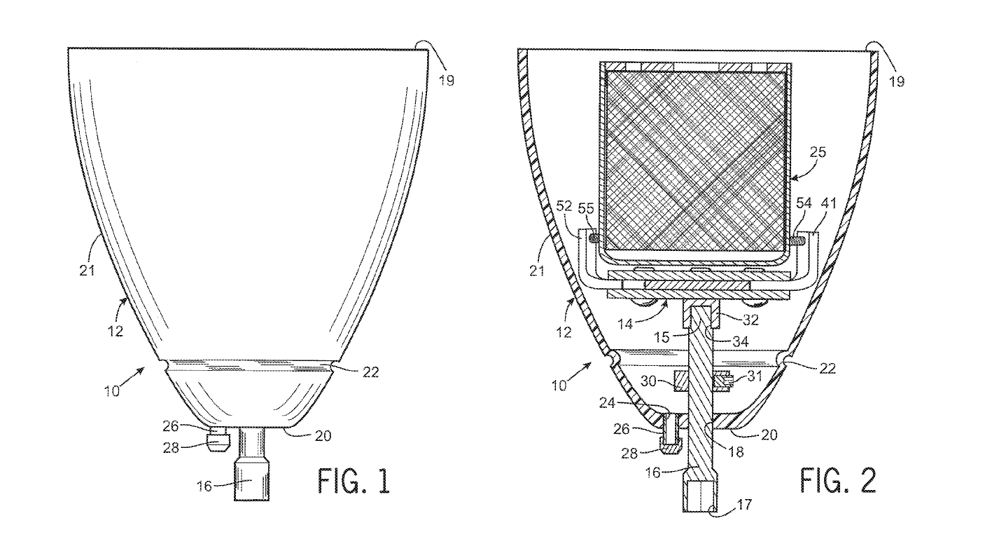

With initial reference to FIGS. 1 and 2, an oil filter removal tool 10 comprises an adjustable oil filter wrench 14 inside a flexible boot 12 and attached to a wrench extension shaft 16 that extends through a first aperture 18 in the boot. The inner end 15 of the wrench extension shaft 16 has a square cross section so as to fit into a square aperture in the oil filter wrench 14 and the outer end has a square aperture 17 for receiving a standard wrench handle (not shown).

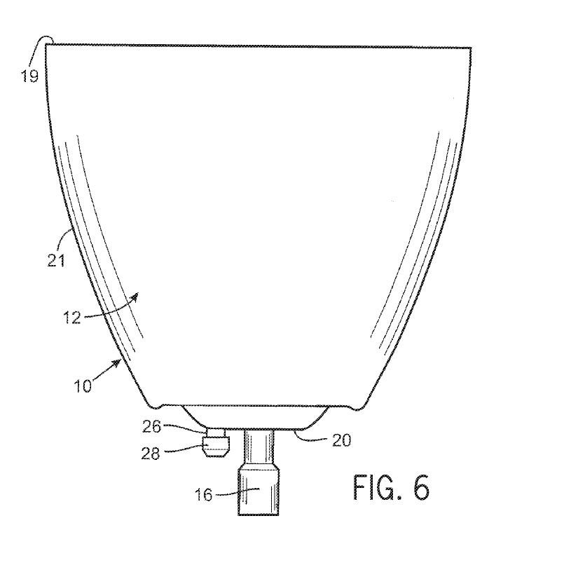

The boot 12 has a curved frusto-conical shape with a circular cross section, similar to half of an American style football divided at the midpoint between its two small ends. The boot 12 surrounds the oil filter wrench 14 and has a first end 19 that is open to allow the boot to extend around the oil filter 25 held in the wrench during removal as shown in FIG. 2. The opposite second end 20 of the boot 12 is closed and is smaller than the first end 19. The exterior surface 21 of the boot is smooth, curving inward going from the relatively large first end 19 to the smaller second end 20. The boot 12 is made of a resilient material, such as rubber or plastic that is flexible yet retains the frusto-conical normal shape. That resiliency allows the boot to collapse or compress longitudinally to accommodate oil filters of different lengths, as depicted in FIG. 6.

Referring again to FIGS. 1 and 2, that compression is facilitated by an annular groove 22 in the exterior surface 21 of the boot 12 and spaced a short distance from the closed second end 20.

The closed second end 20 of the boot has a second aperture 24 therein from which a tubular drain coupling 26 extends outward. A closure, in the form of a removable cap 28, closes the tubular drain coupling 26 and prevents oil from flowing from the boot 12 out through the drain tube. It should be understood that other types of closures, such as a plug for example, may be used to block oil flow through the drain tube.

The wrench extension shaft 16 extends through the first aperture 18 in the closed second end 20 of the boot. The boot wall around the first aperture 18 snuggly engages the wrench extension shaft 16 to prevent oil inside the boot from leaking out, yet that engagement is not so tight as to impede the wrench extension shaft from rotating in the first aperture. Optionally, a seal between the boot and the wrench extension shaft can be provided by an 0-ring placed in a groove around the first aperture. The smaller inner end 15 of the wrench extension shaft 16 is able to be pushed through the first aperture 18 during assembly of the tool 10. A collar 30 extends around the interior portion of the wrench extension shaft 16 and is affixed thereto by a set screw 31 or other securing mechanism. Alternatively, the collar 30 may be a snap ring that fits into an annular groove around the wrench extension shaft 16. The collar 30 prevents the wrench extension shaft 16 from inadvertently being pulled out of the boot 12 through the first aperture 18. However, unscrewing the set screw 31 allows the collar 30 to be released so that the wrench extension shaft 16 can be removed from the boot, if necessary.

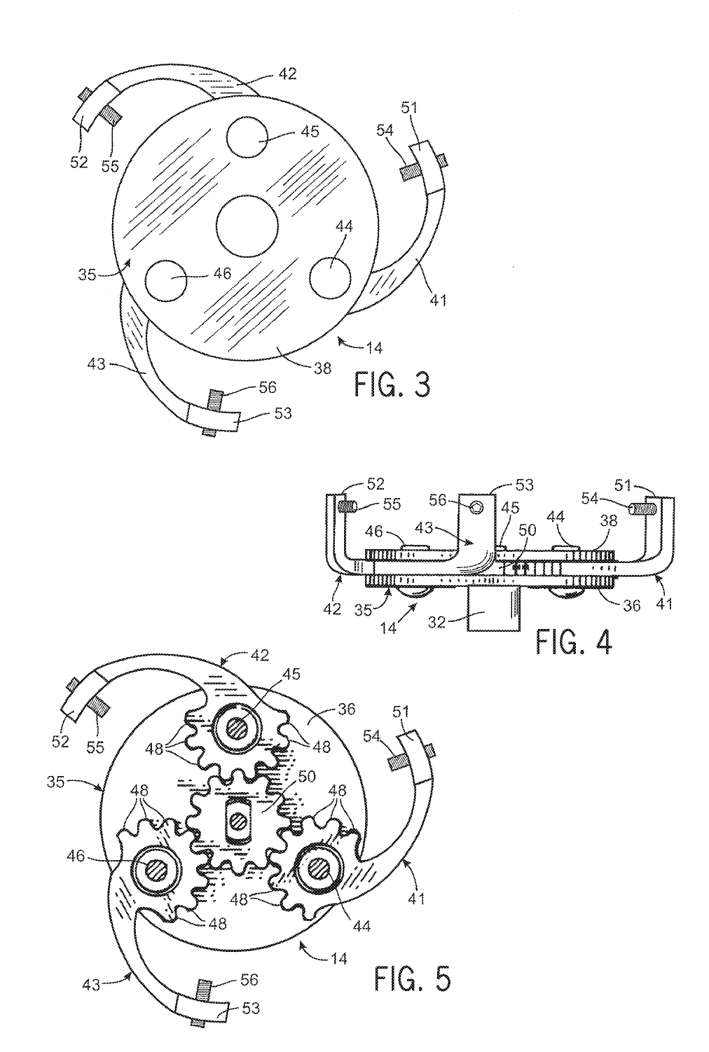

As seen in FIG. 2, the inner end 15 of the wrench extension shaft 16 engages the oil filter wrench 14. For example, that inner end 15 has a square cross-section that removably fits into a square aperture 34 in a drive coupling 32 of the oil filter wrench 14. With additional reference to FIGS. 3-5, the oil filter wrench 14 has a body 35 formed by circular first and second plates 36 and 38 that are spaced apart with proximate end sections of three fingers 41, 42 and 43 received there between. As seen specifically in FIGS. 4 and 5, the three fingers 41-43 curve in a common plane outward from the first and second plates 36 and 38 of the body 35. The three fingers 41, 42 and 43 rotate on the shafts of three rivets 44, 45 and 46, respectively, that extend through the first and second plates 36 and 38. The proximate end section of each finger 41-43 is enlarged and has gear teeth 48. Those gear teeth 48 mesh with the teeth of a circular gear 50 that is centrally located among the fingers 41-43 and is rotationally connected between the first and second plates 36 and 38 of the body. The circular gear 50 is attached to the drive coupling 32 and rotates when the drive coupling is driven by the wrench extension shaft 16 received in the square aperture 34 of the drive coupling. Rotation of the circular gear 50 inside the body 35 causes the three fingers 41-43 to pivot away from or toward the circumferential edges of the first and second plates 36 and 38, depending upon the direction of that rotation. FIGS. 3-5 depict the oil filter wrench 14 in a pivoted state in which the fingers 41-43 project outward approximately halfway along their travel range.

The fingers 41-43 are arcuate, curving alongside the circumferential edges of the first and second plates 36 and 38. As shown in FIG. 4, the remote end sections 51, 52, and 53 of the fingers 41, 42, and 43 respectively, that are opposite to the geared proximate end sections, bend upward toward the second plate 38 and project beyond the major exterior surface of the second plate. Thus the remote end sections 51-53 are transverse (e.g. orthogonal) to the common plane of the geared proximate end sections and the curving portions of the fingers 41-43. These bent fingers form a pocket in which the oil filter 25 is received when the removal tool 10 is in use, as shown in FIG. 2. The inner surface of each finger's remote end section 51, 52, and 53 has a projection, in the form of a rod 54, 55, and 56, projecting inwardly there from for grabbing the housing of the oil filter 25. For example, each rod 54-56 is illustrated as a set screw threaded into an aperture in the corresponding finger's remote end section 51-53 and preferably held therein by a thread locking compound, such as Loctite® brand. Although use of set screws enables the rods to be replaced, if necessary due to wear, unthreaded rods that are press fitted into the finger apertures, welded, or otherwise adhered thereto may be used as the projections for gripping the oil filter. The projections alternatively may be the rod or shaft of a machine screw or have a geometric cross section other than circular.

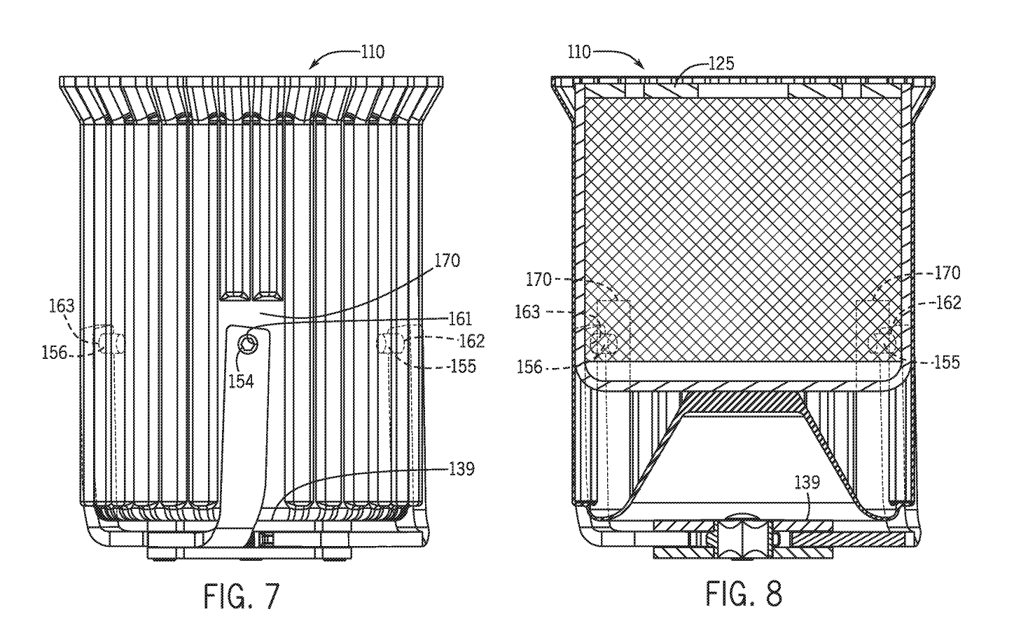

According to another non-limiting embodiment of the present invention as seen in FIGS. 7 and 8, an oil filter removal tool 110 comprises an adjustable oil filter wrench 114 outside a flexible boot 112. The oil filter wrench 114 has a drive coupling 132 comprising a square aperture 134 for receiving a standard wrench handle (not shown).

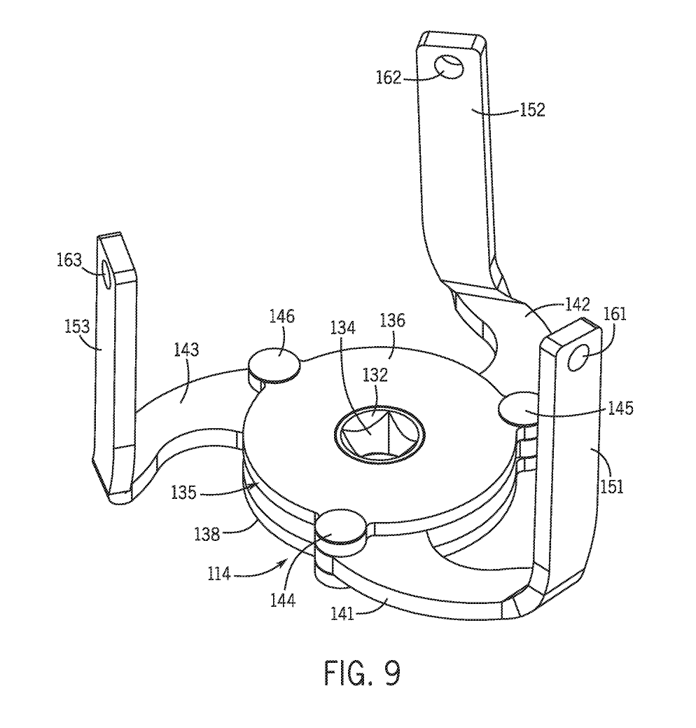

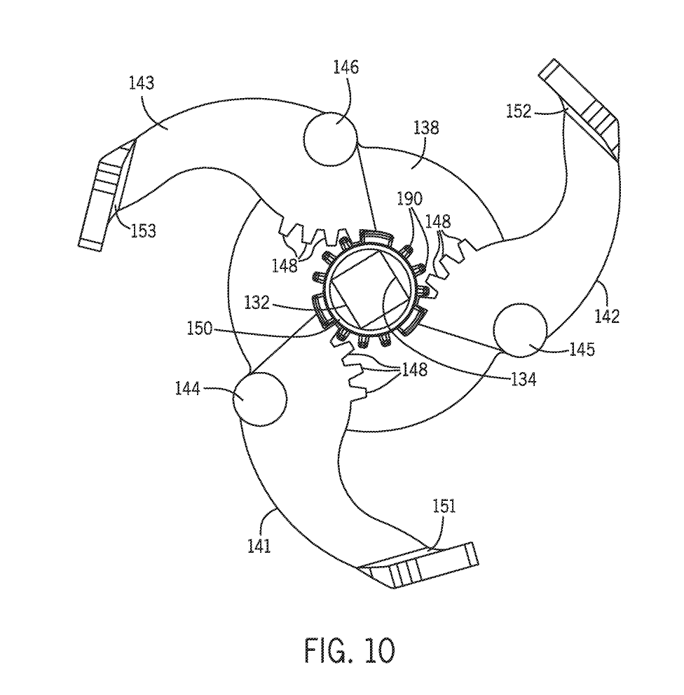

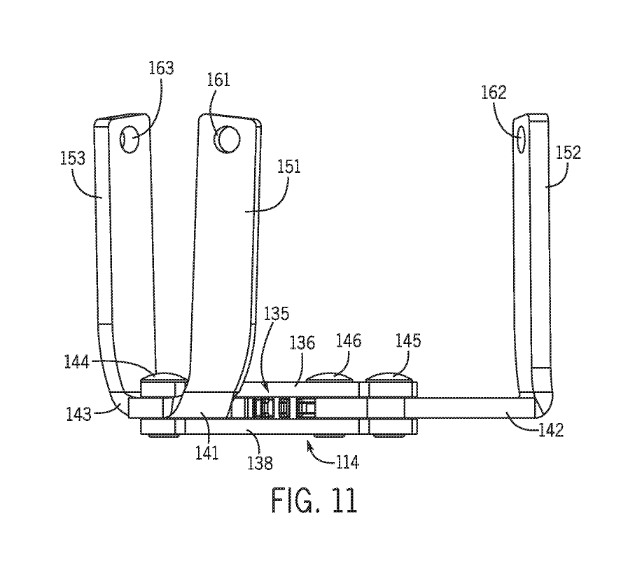

With reference now to FIG. 9-11, the oil filter wrench 114 has a body 135 formed by circular first and second plates 136 and 138 that are spaced apart with proximate end sections of three fingers, 141, 142, and 143 received there between. The fingers 141, 142, and 143 curve in a common plane outward from the first and second plates 136 and 138 of the body 135, as seen in FIGS. 10 and 11. The three fingers 141, 142, and 143 rotate on the shafts of three rivets 144, 145, and 146, respectively, which extend through the first and second plates 136 and 138. The proximate end section of each finger 141-143 is enlarged and has gear teeth 148. Those gear teeth 148 mesh with the teeth of a circular gear component 150 that is centrally located among the fingers 141-143 and is rotationally connected between the first and second plates 136 and 138 of the body.

The circular gear component 150 comprises a plurality of teeth 190, which may be uniformly sized. However, as seen in FIG. 10, the circular gear component 150 may also comprise teeth 190 of different sizes, such that the rotational range of fingers 141-143 is affected. The circular gear component 150 also comprises the drive coupling 132, which comprises a square aperture 134 for receiving a standard wrench handle (not shown), wherein the drive coupling extends through the circular gear component 150, such that the standard wrench handle (not shown) is in direct connection with the circular gear component 150 when the wrench handle is connected to the tool 110. The circular gear component 150 rotates when the standard wrench handle (not shown) is rotated. Rotation of the circular gear component 150 inside the body 135 causes the three fingers 141-143 to pivot away from or toward the circumferential edges of the first and second plates 136 and 138, depending upon the direction of that rotation. FIG. 10 depicts the oil filter wrench 114 in a pivoted state in which the fingers 141-143 project outward at approximately a maximum of their travel range.

The fingers 141-143 are arcuate, curving alongside the circumferential edges of the first and second plates 136 and 138. As shown in FIG. 11, the remote end sections 151, 152, and 153 of the fingers 141, 142 and 143 respectively, that are opposite to the geared proximate end sections, bend upward toward the second plate 138 and project beyond the major exterior surface of the second plate. Thus the remote end sections 151-153 are transverse (e.g. orthogonal) to the common plane of the geared proximate end sections and the curving portions of the fingers 141-143. These bent fingers form a pocket in which the oil filter 125 is received when the removal tool 110 is in use, as shown in FIGS. 7 and 8. The inner surface of each finger's remote end section 151, 152, and 153 has a projection, in the form of a rod 154, 155, and 156, projecting inwardly there from for compressively contacting an exterior surface of a boot 121, a contact surface 170 or a housing of the oil filter 125. For example, each rod 154-156 is illustrated as a set screw threaded into an aperture 161, 162, and 163 in the corresponding finger's remote end section 151-153 and preferably held therein by a thread locking compound, such as Loctite® brand. Although use of set screws enables the rods to be replaced, if necessary due to wear, unthreaded rods that are press fitted into the finger apertures 161-163, welded, or otherwise adhered thereto may be used as the projections for gripping the oil filter. The projections alternatively may be the rod or shaft of a machine screw or have a geometric cross section other than circular.

The boot 112 may have a cylindrical shape with a circular cross section. The boot 112 surrounds the oil filter 125 and has a first end 119 that is open to allow the boot to extend around the oil filter 125 during removal, as shown in FIGS. 7 and 8. The opposite second end 120 of the boot 112 is closed and is smaller than the first end 119.

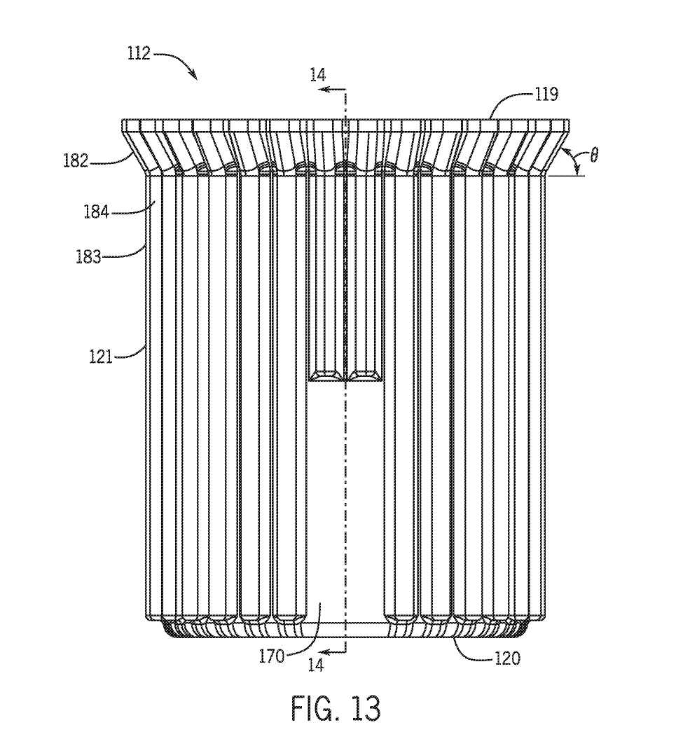

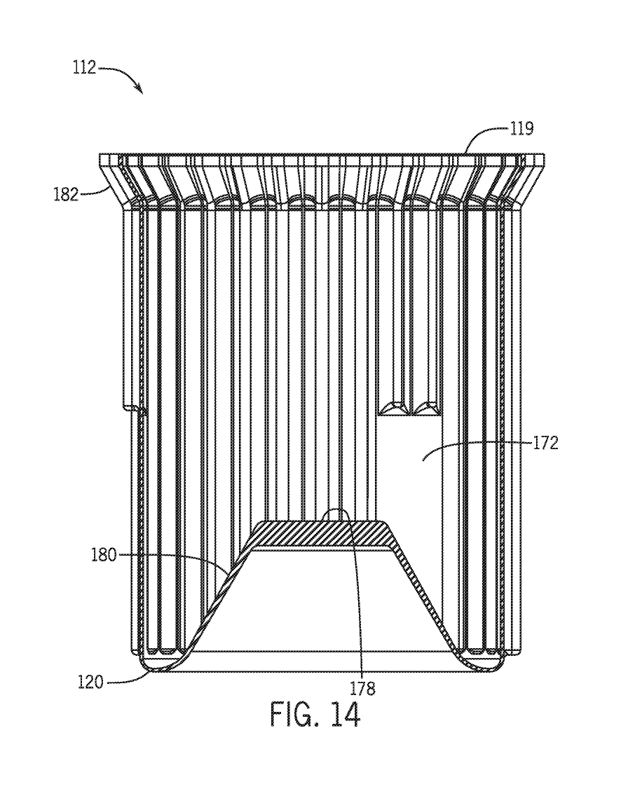

In one non-limiting example, the boot 112 comprises a tapered section 182 and a cylindrical section 183, as seen in FIG. 13. The cylindrical section 183 extends upward from the second end 120 towards the first end 119. The tapered section 182 extends upward from the cylindrical section 183 towards the first end 119. The tapered section 182 also extends radially outward from the center of the boot 112 and gradually increases the diameter of the boot until a desired diameter is reached. In some embodiments the taper angle θ is greater than 0 degrees and less than 90 degrees, although other angles can be used as well. This tapered section 182 allows for better catching of fluid during removal of the oil filter 125.

The exterior surface 121 of the boot can be smooth, or can contain a plurality of flutes 184 which extend in a direction orthogonally away from the second end 120 to the first end 119 around the outer circumference of the boot 112. The plurality of flutes 184 may be of the same length or may vary. The plurality of flutes 184 may be distributed about the entire outer circumference of the boot 112, or may be placed sporadically. In one non-limiting example, the flutes 184 can be uniformly distributed about the entire outer circumference of the boot 112. The number of flutes 184 on the outer circumference of the boot can vary based upon the type of material used, size of the boot 112, or other factors. Similarly, the arc size of each flute 184 can fluctuate or can be uniform, and can be chosen based upon factors such as material used, size of the boot 112, or other factors. The flutes 184 allow the object to flex under pressure, thereby providing better gripping surface for a mechanic, should the mechanic choose to grab the boot 112 in isolation. The flutes 184 also decrease the surface area available to be gripped by the mechanic, thus limiting the heat transfer through the object to the mechanic, and providing some protection to the mechanic from potential burns that may occur when hot fluid is present in the boot 112.

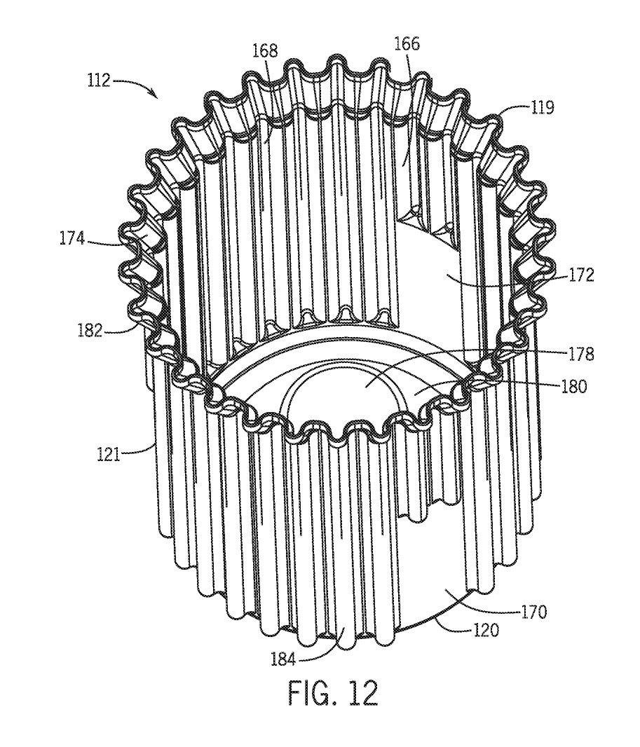

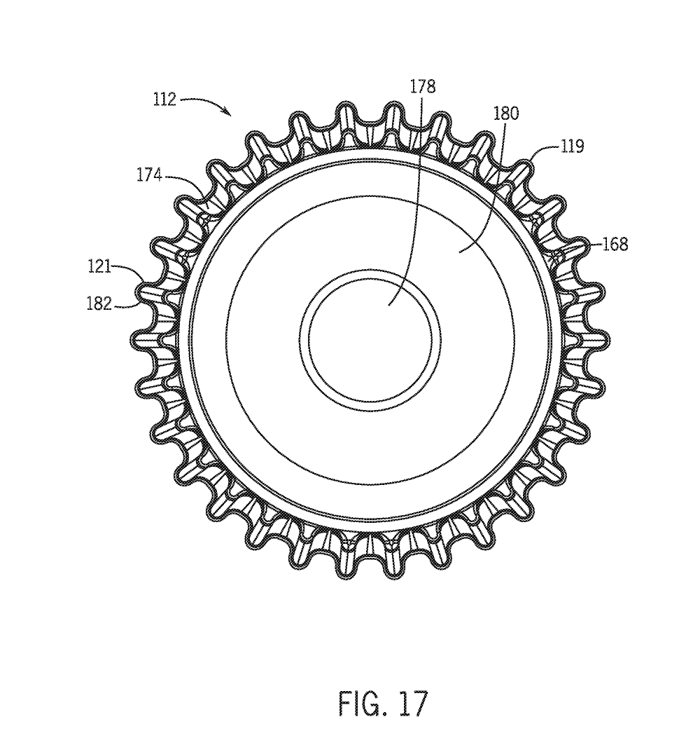

Similar to the exterior surface 121 of the boot, the interior surface 168 of the boot can be smooth or can contain a plurality of flutes 166 which extend in a direction orthogonally away from the second end 120 towards the first end 119 around the inner circumference of the boot 112, as can be seen in FIG. 12. The plurality of flutes 166 may be of the same length or may vary. The plurality of flutes 166 may be distributed about the entire inner circumference of the boot or may be placed sporadically. In one non-limiting example, the flutes can be uniformly distributed about the entire inner circumference of the boot 112. In another non-limiting example, the flutes 166 may align with the flutes 184 in the exterior surface of the boot 112, as is seen in FIG. 17. The number of flutes present along the inner circumference of the boot can vary based upon the type of material used, size of the boot 112, or other factors. Similarly, the arc size of each flute 166 can fluctuate or can be uniform, and can be chosen based upon factors such as material used, size of the boot 112, or other factors. The flutes 166 optimize the flow of oil through the boot, allow greater oil volume in the boot, and distribute the fluid more efficiently throughout the boot. The flutes 166 also allow the boot to flex, therefore making it easier to fit the boot 112 around the outside of an oil filter 125.

In examples of the boot 112 that comprise a tapered section 182, the tapered section may have a smooth interior surface and smooth exterior surface, a smooth interior surface and fluted exterior surface, a fluted interior surface and a smooth exterior surface, or a fluted interior surface and a fluted exterior surface, or some other surface composition. In one non-limiting example, the quantity of flutes in the exterior surface of the tapered section 182 of the boot 112 is equal to the quantity of flutes in the exterior surface of the cylindrical section 183. In another non-limiting example, the flutes in the exterior surface of the tapered section 182 of the boot 112 are aligned with the flutes in the exterior surface of the cylindrical section 183. In another non-limiting example, the quantity of flutes in the interior surface of the tapered section 182 of the boot 112 is equal to the quantity of flutes in the interior surface 168 of the boot 112. In yet another non-limiting example, the flutes on the interior surface of the tapered section align with the flutes in the interior surface of the cylindrical section, as is shown in FIGS. 12 and 17. In examples that comprise a tapered section 182 without flutes, a secondary seal or lip at the first end 119 of the boot could be used. An over-molded. or removable drip seal could be utilized to perform a function similar to that of the fluted tapered section 182 of the boot 112. Those skilled in the art will appreciate that other similar seals or designs may perform the function of receiving or catching oil or other fluid during the use of the oil filter removal tool 110.

In some non-limiting examples of the boot 112, the boot may have one or more clearance landings 170 located about the exterior surface 121 of the boot, as shown in FIGS. 12 and 13. The clearance landings 170 may be comprised of the same material as the rest of the hoot 112, or may be comprised of different material. The clearance landings 170 are designed to provide a flat engagement surface for the oil filter wrench rods 154-156. In one non-limiting example, three clearance landings are spaced evenly apart about the outer circumference of the boot 112. The clearance landings 170 are not fluted, and allow clearance for the oil filter wrench 114 to contact the boot 112. In some examples, the clearance landings 170 have a secondary membrane where the rods 154-156 would compressively engage the oil filter 125 when the oil filter wrench 114 is tightened. In some non-limiting examples, the rods 154-156 would extend through the membrane, coming into physical contact with the oil filter 125 when the oil filter wrench 114 was tightened. In such cases, the secondary membrane would comprise a resilient material such that a clearance landing 170 could reseal itself without leaking for future use.

In some non-limiting examples of the boot 112, the boot may also comprise one or more clearance landings 172 located about the interior surface 168 of the boot, as shown in FIGS. 12 and 14. The clearance landings 172 may be smooth, or may be textured, so as to increase the available frictional force and provide improved grip. In one non-limiting example, three clearance landings are spaced evenly apart about the inner circumference of the boot 112. In another non-limiting example, the quantity of clearance landings 172 is equal to the quantity of clearance landings 170 located on the exterior surface 121 of the boot. In yet another non-limiting example, the clearance landings 172 of the interior surface of the boot and the clearance landings 170 of the exterior surface of the boot are substantially concentric with each other and aligned such that each exterior surface clearance landing 170 and interior surface clearance landing 172 shares a common set of normal vectors.

The clearance landings 170 and 172 may extend along the entire interior and exterior surfaces 121 and 168 of the cylindrical portion of the boot 112, or may be smaller. In one non-limiting example, the clearance landings 170 and 172 extend from the second end 120 to approximately halfway up the cylindrical section, as shown in FIGS. 12-14. In another non-limiting example, the area located above the interior surface clearance landings 172 could have a raised area or oil foil to divert or reduce the oil flow in the area above the clearance landings. In examples in which the rods 154-156 extend through both the exterior surface clearance landing 170 and interior surface landing 172, this feature would limit oil that could potentially leak through the holes created in the secondary membrane of the boot 112.

It should be understood that not all examples of the boot 112 contain clearance landings 170 and 172. In some non-limiting examples, the wrench can contact the fluted portion of the exterior surface 121, and self-center itself between the flutes 184 of the exterior surface. Additionally, the secondary membrane is optional. In some examples of the boot 112, the boot is comprised of a single material.

The second end of the boot 120 may be substantially flat, or may comprise a frusto-conical diaphragm shape as shown in FIG. 14. The diaphragm 180 extends away from the second surface 120, into the cylindrical portion 183 of the boot 112. In one non-limiting example, the diaphragm 180 comprises a flat surface 178. In other non-limiting examples, the diaphragm maintains a substantially hemispherical shape.

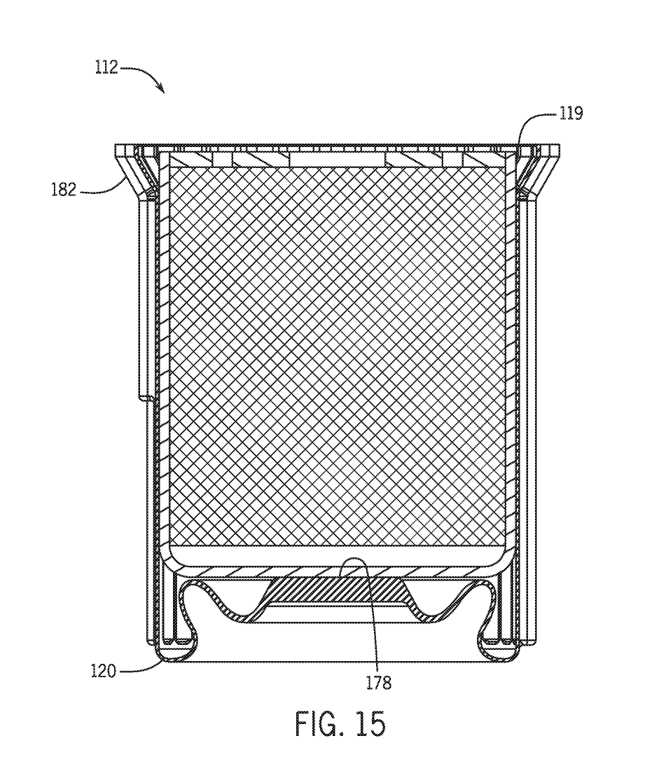

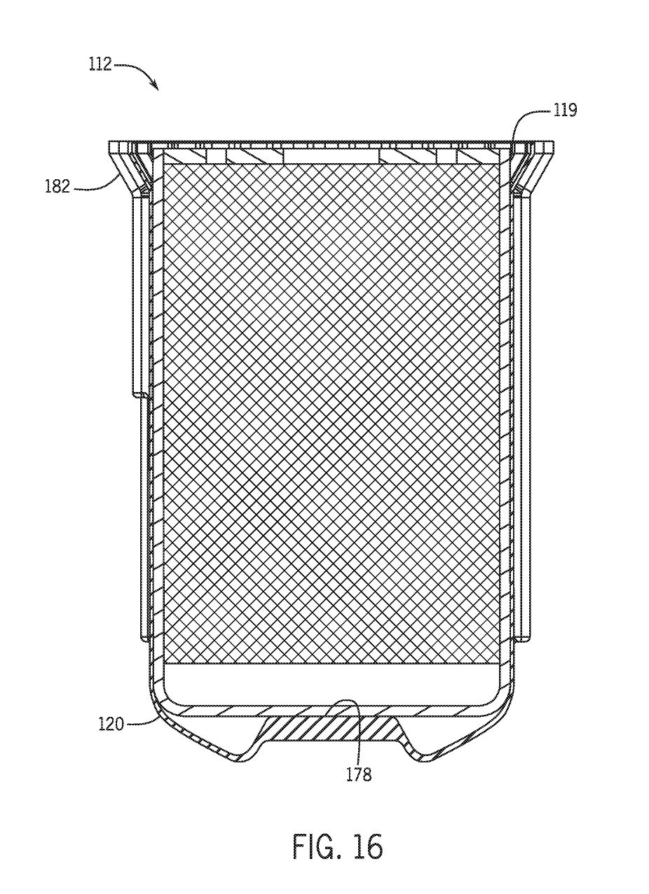

The diaphragm 180, like the rest of the boot 112, is comprised of a flexible material, and is convertible, such that a compressive force on the flat surface 178 or the top of the curved surface (not shown) tends to cause the diaphragm 180 to become inverted, extending towards the second end 120 of the boot, as shown in FIG. 15. In some embodiments, the diaphragm 180 can be completely inverted, as shown in FIG. 16. As can be seen in FIG. 16, due to the ability of the diaphragm 180 to invert, some embodiments of the oil filter removal tool 110 may be able to accommodate oil filters 125 that have a greater height than the height of the boot 112 in its resting state, shown in FIG. 14. The diaphragm 180 allows the boot 112 to accommodate oil filters 125 of different lengths while maintaining a satisfactory fluid capacity in the boot. The diaphragm 180 can be a single continuous shape, or can comprise several stages, such that different oil filter 125 lengths would trigger the inversion of a certain quantity of stages. As such, the diaphragm 180 would operate similar to that of an accordion. When the compressive force from the oil filter 125 is removed, the diaphragm 180 returns to its original shape as shown in FIG. 14, either on its own due to the resilient nature of the material and shape, or by placing pressure on the bottom side of the diaphragm, and pushing the diaphragm upward towards the boot first end 119.

Although not shown in the Figures, the boot 112 may have an aperture extending through the second end 120 therein from which a tubular drain coupling extends outward (not shown), similar to item 26 as shown in FIGS. 1, 2, and 6. A closure, in the form of a removable cap, closes the tubular drain coupling and prevents oil from flowing from the boot 112 out through the drain tube. The closure could be in the form of item 28, as shown in FIGS. 1, 2, and 6. It should be understood that other types of closures, such as a plug for example, may be used to block oil flow through the drain tube.

The boot 112 may be comprised of many different materials. In one non-limiting example, the boot 112 comprises a transparent or translucent material to allow a user to see through the boot 112 when he or she is removing the oil filter 125 to aid in the removal process. In another non-limiting example, the boot 112 comprises an opaque material. The boot 112 may comprise a plastic, a cross-linked polymer, silicone, rubber, or any other flexible material suitable for removal of the oil filter 125.

It should be understood that many different sizes of the boot 112 have been contemplated and may be used in conjunction with the oil filter removal tool 110. While the oil filter removal tool 110 has been created to fit multiple sizes of oil filters 125, the height, diameter, taper size, flute size, surface thickness, and other properties of the boot 112 may all be further tailored to fit oil filters 125 of different sizes. It should also be understood that the orientation of the plurality of flutes may be adjusted. In some examples, a helical flute may be used. Any flute which suitably directs the flow of oil towards the base of the boot 112 can serve this purpose.

### Industrial Applicability

To use the oil filter removal tool 10, the flexible boot 12 is slid over the oil filter 25 until the exposed end of the filter is received within the end sections 41-43 of the fingers 41-43 of the adjustable oil filter wrench 14, as shown in FIG. 2. If necessary, the boot 12 can deform to fit into a tight space around the oil filter. A wrench handle (not shown) is inserted into the square aperture 17 in the exterior end of the wrench extension shaft 16 and is used to rotate the extension shaft in a counter-clockwise direction. This rotation causes the circular gear 50 inside the wrench 14 to pivot the fingers 41-43 so that the inner ends of their rods 54-56 engage and firmly grip the housing of the oil filter 25 which is automatically centered in the wrench. The relatively small contact areas between the projecting rods and the oil filter housing concentrate the gripping force. Continued rotation of the oil filter wrench 14 causes the oil filter to rotate with the wrench, thereby loosening the filter from the engine. As that is occurring, the boot 12 can either rotate with the oil filter wrench 14 or remain stationary.

After a gap is created between the oil filter 25 and the engine, oil may leak there through. That leaking oil will drain into the boot 12 and be retained therein. Once the oil filter is free of the engine, the combination of the filter 25 and the removal tool 10 can be placed over a used oil receptacle and the oil poured from the boot through the open first end 19.

In some engines, a relatively large amount of oil remains in the attached oil filter and adjacent section of the engine after the oil pan has been drained. In this instance, before the oil filter 25 is loosened, the cap 28 is removed and a hose (not shown) is attached to the tubular drain coupling 26 of the boot. That hose leads to the used oil receptacle so that the leaking oil, caught in the boot 12 during the removal process, can immediately drain into that receptacle.

After the oil filter 25 has been removed entirely from the engine, the drive coupling 32 is rotated clockwise to release the grip of the fingers 41-43 on the filter housing, thereby enabling the oil filter to be taken out of the oil filter removal tool 10.

To use the oil filter removal tool 110, the boot 112 is slid over the oil filter 125 until the exposed end of the filter is received entirely within the boot. In some embodiments, the diaphragm 180 of the boot 112 can be fully inverted prior to contacting the boot 112 with the oil filter wrench 114, while in others the boot 112 is located above the first plate 136 prior to sliding the boot 112 over the oil filter 125. The fingers 141-143 of the oil filter wrench 114 are rotated such that contact occurs between the rods 154-156, the boot 112, and the oil filter 125. If necessary, the boot diaphragm 180 can invert to accommodate oil filters of greater length. A wrench handle (not shown) is inserted into the square aperture 134 of the drive coupling 132. The wrench is rotated in a counter-clockwise direction, such that the rotation causes the circular gear component 150 inside the wrench 114 to pivot the fingers 141-143 so that the inner ends of their rods 154-156 compressively engage the housing of the oil filter 125 which is automatically centered in the wrench. The relatively small contact areas between the projecting rods, the boot, and the oil filter housing concentrate a gripping force. Continued rotation of the oil filter wrench 114 causes the oil filter to rotate with the wrench, thereby loosening the filter from the engine. As that is occurring, the boot rotates with the oil filter wrench 114.

After a gap is created between the oil filter 125 and the engine, oil may leak there through. That leaking oil will drain into the boot 112 and be retained therein. Once the oil filter is free of the engine, the combination of the filter 125 and the removal tool 110 can be placed over a used oil receptacle and the oil poured from the boot through the open first end.

After the oil filter 125 has been removed entirely from the engine, the drive coupling 132 is rotated clockwise to release the grip of the fingers 141-143 on the filter housing, thereby enabling the oil filter to be taken out of the removal tool 110.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A tool for removing an oil filter from an engine, said tool comprising:
a wrench having a body from which a plurality of fingers pivotally project, wherein each finger has a remote end section from which a rod extends in an orientation to engage the oil filter, the wrench further comprising a drive mechanism that when rotated causes the fingers to pivot with respect to the body;
a boot, of flexible material, having a cylindrical shape with a first end that is open, a second end that is closed and that is smaller than the first end, and an exterior surface, wherein the boot exterior surface is located such that each rod of the wrench contacts the exterior surface of the boot prior to engaging the oil filter; and
a shaft attached to the drive mechanism of the wrench.

2. The tool as recited in claim 1 wherein each rod of the wrench has screw threads and is threaded into an aperture in a respective one of the plurality of fingers.

3. The tool as recited in claim 1 wherein the boot has a fluted exterior surface.

4. The tool as recited in claim 1, wherein the interior surface of the boot comprises a plurality of flutes.

5. The tool as recited in claim 3 wherein the fluted exterior surface further comprises non-fluted clearance landings.

6. The tool as recited in claim 1 wherein the wrench further comprises:
a circular gear component that has teeth and that is rotationally connected to the body, wherein the circular gear component also serves as the drive mechanism; and wherein the plurality of fingers are pivotally connected to the body and curve outward there from in a common plane, each finger having a proximate end section with teeth that mesh with the teeth of the circular gear, and wherein the remote end section is transverse to the common plane.

7. A tool for removing an oil filter from an engine, said tool comprising:
a wrench having a body from which a plurality of fingers pivotally project, wherein each finger has a remote end section from which a rod extends in an orientation to engage the oil filter, the wrench further comprising a drive coupling that when rotated causes the fingers to pivot with respect to the body;
a boot, of flexible material, having a first end that is open, a second end that is closed, an interior surface and an exterior surface, the interior surface comprising a plurality of flutes, wherein the boot exterior surface is located such that each rod of the wrench contacts the exterior surface of the boot prior to engaging the oil filter; and
a shaft attached to the drive coupling of the wrench.

8. The tool as recited in claim 7, wherein each rod of the wrench has screw threads and is threaded into an aperture in a respective one of the plurality of fingers.

9. The tool as recited in claim 7, wherein the boot comprises a cylindrical section and a tapered section.

10. The tool as recited in claim 7, wherein the exterior surface of the boot comprises a plurality of flutes.

11. The tool as recited in claim 7, wherein the exterior surface of the boot comprises a plurality of clearance landings.

12. The tool as recited in claim 11, wherein the interior surface of the boot comprises a plurality of clearance landings, wherein the clearance landings are not fluted.

13. The tool as recited in claim 7, wherein the boot comprises a convertible diaphragm extending into the boot.

14. The tool as recited in claim 9, wherein an interior surface of the cylindrical section of the boot comprises a plurality of flutes.

15. The tool as recited in claim 9, wherein an interior surface of the tapered section comprises a plurality of flutes.

16. The tool as recited in claim 7, wherein the flutes extend vertically away from the second end towards the first end.

17. The tool as recited in claim 11, wherein the plurality of clearance landings comprise a secondary membrane, wherein the secondary membrane is comprised of a resilient material such that the secondary membrane is capable of resealing itself if the material is punctured.

18. The tool as recited in claim 7, wherein the boot is comprised of a transparent or translucent material.

19. The tool as recited in claim 10, wherein the quantity of flutes on the exterior surface of the boot and the quantity of flutes on the interior surface of the boot are equal.

20. The tool as recited in claim 19, wherein the flutes on the exterior surface of the boot and the flutes on the interior surface of the boot are aligned concentrically.

21. The tool as recited in claim 7 wherein the wrench further comprises:
a circular gear component that has teeth and that is rotationally connected to the body, wherein the circular gear component also serves as the drive mechanism; and wherein the plurality of fingers are pivotally connected to the body and curve outward there from in a common plane, each finger having a proximate end section with teeth that mesh with the teeth of the circular gear, and wherein the remote end section is transverse to the common plane.
